(19) United States
(12) Patent Application Publication
(10) Pub. No.: US 2011/0264684 A1
(43) Pub. Date: Oct. 27, 2011

(54) METHOD AND SYSTEM FOR UPDATING CONTACT INFORMATION

(76) Inventors: Eytan Shafigi, Beverly Hills, CA (US); Nir Shay, Beverly Hills, CA (US)

(21) Appl. No.: 12/764,769

(22) Filed: Apr. 21, 2010

(51) Int. Cl. G06F 17/30

(52) U.S. Cl. 707/769; 707/803; 707/E17.014; 707/E17.044

(57) ABSTRACT

A method for creating a user's address book in a database that creates a code associated with the user such that when the user's address book is updated, the updated information is imported into the platforms of members registered in the database through the code. A method for scanning a platform(s) of a user for Email IDs to determine if the Email ID already exists in the user's address book, and if it does not, checking the database for the existence of the Email ID, wherein if the Email ID is registered in the database, the user's address book is updated with the code of the user associated with the Email ID, and the code is subsequently imported into the user's platforms. If the Email ID does not exist in the database, a link between the Email ID and the user's platform(s) is created and stored into long term memory.

### CROSS-REFERENCE TO RELATED APPPLICATION

None

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a method for updating contact information, and more particularly to an improved method for creating an address book and updating the contact information of at least one user into at least one platform using a website.

With the increasing popularity of internet, social networking websites have become versatile. The social networking websites bring people together through emails and instant messages. Each user creates his own profile while registering into these websites. These networking websites utilize a large database for storing user details like personal information, professional information, contact information, etc. The websites allow the user to edit and update individual profile details. This requires updating the database to incorporate changes made in the user profile.

Several methods for storing and updating contact information have been developed in the art. For example, U.S. Pat. No. 6,829,348 issued to Schroeder on Dec. 7, 2004 describes a system and method for providing complete customer contact management across a variety of customer contact channels that enables clients to manage and develop relationships with their customers. In this method, the clients obtain the customer contact information from the various customer contact channels and use this information to increase sales and enhance business productivity.

Another prior art described in U.S. Pat. No. 6,374,259 issued to Celik on Apr. 16, 2002 provides a method and apparatus for storing and retrieving business contact information in a computer system. The method assigns a unique user identification number to a first user and stores information related to the first user in a remote database that is operatively coupled to a remote computer. A second user accesses the remote database over a network to retrieve the information related to the first user by entering the unique user identification number. The apparatus includes a database interface module that transfers the business contact information between the remote database and the remote computer.

U.S. Pat. No. 6,269,369 issued to Robertson on Jul. 31, 2001 provides a network-computer based personal contact manager system that maintains and updates a set of user information stored in a relational database on a networked server. The personal contact manager system allows each user to specify on an individual basis which of their contacts are accessible to other users. The system issues notifications to a user's contacts when the user changes his information or when a preset event, such as a birthday, as defined by the user, is to occur. The personal contact manager system supports the retrieval of information on the contacts and synchronizes a server database with a personal information manager database of the user.

Most of the above methods for storing and managing contact information have considerable drawbacks. In such methods, the contact information of the user is transferred to remote computers and not to any other communication platforms like, mobile phones, Gmail, Microsoft outlook. Further, such methods include a vast number of processes for updating the contact information. Moreover, such methods include several database access restrictions in retrieving and viewing the updated contact information of the user.

It is therefore, an object of the present invention is to provide a simple method for creating an address book and automatically updating the contact information of a user and “pushing” the contact information to the communication platforms of other users. Another object of the invention is to provide a user friendly method that avoids the tedious process involved in updating the contact information of the user. Other objects of the present invention will become better understood with reference to appended Summary, Description and Claims.

### SUMMARY

The present invention is a method for creating a user's address book and updating contact information of at least one user into at least one platform using a website. The user registers with a database (website) by entering at least one requested information. Upon completing the registration, the database generates at least one code for the user and creates the user's address book. The code holds the contact information of the user. The user logs into the database and performs a search operation for at least one code of at least one member in the database. If the status of the code of the member is private, the user asks permission of the member for displaying the contact information. If the status of the code is public, the contact information of the member is displayed and added to the user's address book and the code of the member is “pushed” (imported) into the platform(s) of the user.

For updating the contact information of the user stored in at least one platform of the member, the user updates the contact information stored in the user's address book (in the database). The member's address book (in the database) having the code of the user is automatically updated with the contact information of the user and the code of the user is “pushed” to the platform(s) of the member.

The database periodically scans at least one platform of a user to add the code of a member to the user's address book. The user's platform(s) are searched for Email IDs. If an Email ID is already present in the user's address book, no action is taken. If an Email ID is not present in the user's address book when the database scans the platform(s), and the Email ID belongs to a member registered with the database, the code corresponding to the Email ID is added to the user's address book—permission may be required if the member's profile is private—and the code is “pushed” to the platform(s) of the user. If the Email ID found in the user's platform(s) belongs to a non-registered person, the database creates a link between the code of the user and the Email ID of the non-registered person, and stores the link in long term memory.

A single user spam filter operation is performed by the database to verify the possibility to send a marketing email to the non-registered person. If there is the possibility to send the marketing email, an email address spam filter operation is performed to verify the possibility to receive the marketing email by the non-registered person. The marketing email may be an invitation for the non-registered person to register with the website.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE DRAWINGS

FIG. 1 is a flowchart of the present invention, illustrating a method for creating a user's address book for at least one user and adding contact information of at least one member registered in a database into the user's address book.

FIG. 2 is a flowchart of the present invention, illustrating a method for updating the contact information of at least one user in the address books and platform(s) of at least one member.

FIGS. 3a-3b are flowcharts of the present invention, illustrating a method for scanning at least one platform of at least one user to add at least one code of at least one member registered in a website to a user's address book, and creating links between the user and Email IDs of non-registered persons and storing the links in long term memory (for marketing purposes and for updating user profiles should the non-registered person later register with the database).

### REFERENCE NUMERALS

10 . . . User A registers into a database

12 . . . Database generates a code and an address book for user A

14 . . . User A logs into the database and database performs a search for the code of member B

16 . . . Checking the status of the code of member B

18 . . . Asks permission from member B to view the contact information

20 . . . Verifying permission from member B

22 . . . Access denied

24 . . . Displays the contact information of member B

26 . . . Adding the code of member B into user A's address book

28 . . . Pushing the code of member B into at least one platform of user A

30 . . . User A updates contact information stored in user A's address book

32 . . . Checking code of user A in member's address book

34 . . . Updation fails

36 . . . Code of user A found in the address book of member B, member C and member D

38 . . . Database updates the address book of member B, member C and member D

40 . . . Code of user A is pushed to at least one platform of member B

42 . . . Code of user A is pushed to at least one platform of member C

44 . . . Code of user A is pushed to at least one platform of member D

46 . . . At least one platform of user A is searched for at least one email id

48 . . . Accessing the at least one Email ID from the at least one platform

50 . . . Checking the at least one Email ID in user A's address book

52 . . . No action taken

54 . . . Checking for the at least one Email ID in a database

56 . . . Code corresponding to the at least one Email ID is added to user A's address book and code is pushed to the at least one platform of user A

58 . . . Creating and storing a link in long term memory

60 . . . Single user spam filter

62 . . . Checking the possibility to send a marketing email

64 . . . No action taken

66 . . . Email address spam filter

68 . . . Checking the possibility to receive the marketing email

70 . . . No action taken

72 . . . Sending marketing email

### DETAILED DESCRIPTION

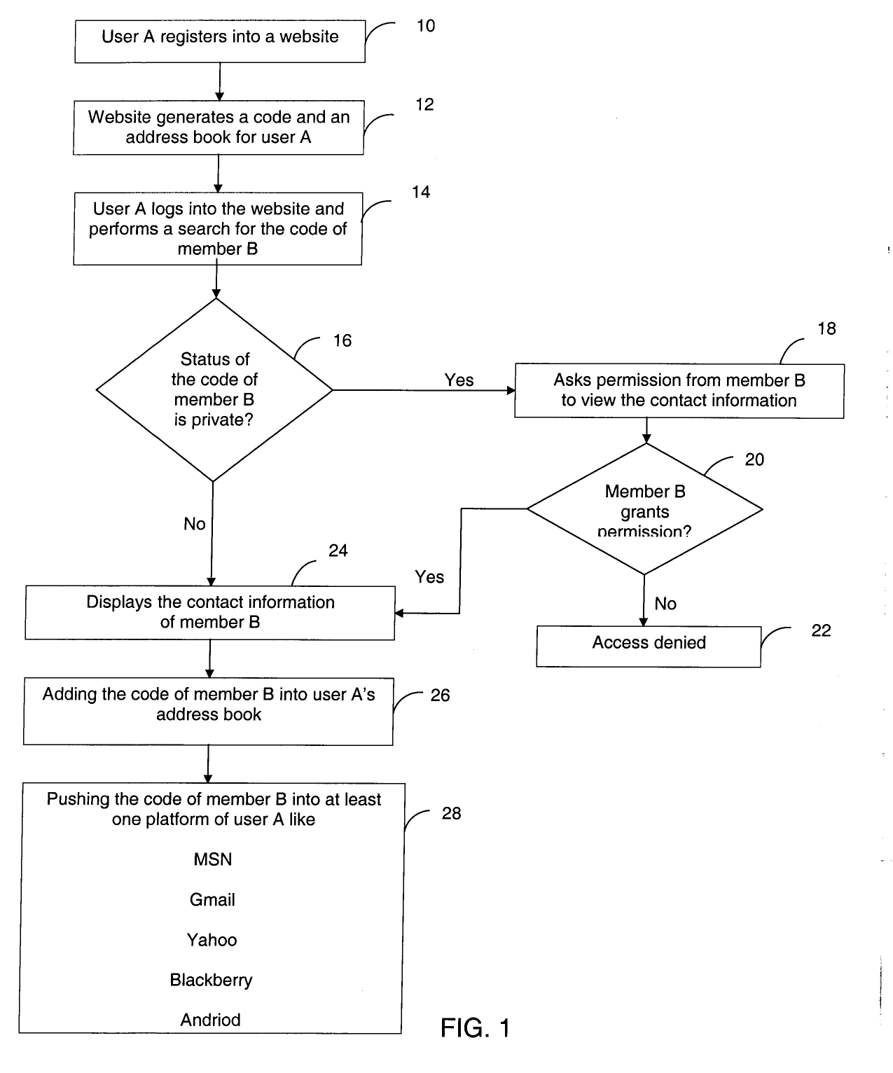

Referring to FIG. 1, a flowchart illustrates an example for creating an address book for user A and adding contact information of member B registered in a database (e.g., through a website) into the address book of user A. The contact information can include a telephone number, email address, phone number, fax number, mailing address, home address, or business address. User A registers into the database by entering at least one requested information as indicated at block 10. The requested information may comprise a name, address, key Email ID, contact numbers and access information for at least one platform. The key Email ID is the primary Email ID entered by user A for registering into the database. The access information for a platform may include a user name and password. Upon completing the registration, the database generates at least one code and creates user A's address book as indicated at block 12. The code includes a set of characters for identifying a user registered in the database. The code holds the contact information of user A such as a phone number, Email ID and residential address. User A logs into the database and performs a search operation for at least one code of member B, for example, through a website associated with the database as shown at block 14. A check is made at block 16 to verify whether the status of the code of member B is private. If the check is evaluated to be true, user A asks permission of member B for displaying the contact information of member B as indicated at block 18. If the check is evaluated to be false, the status of the code is public and the contact information of member B is displayed as indicated at block 24. A check is made at block 20 to verify whether member B grants permission to view the contact information. If the check is evaluated to be true, the contact information of member B is displayed as indicated at block 24, and if the check is evaluated to be false, user A is not able to view the contact information of member B as indicated at block 22. The code holding the contact information of member B is added to user A's address book as shown at block 26, and at least one code of member B is “pushed” (imported into) into the at least one platform of user A as shown at block 28.

The platform may be a web based platform, application based platform or device based platform. The web based platform may include Gmail, Yahoo, Microsoft network (MSN) or America online (AOL). The application based platform may include Microsoft Outlook or Android. The device based platform may include mobile phones and personal digital assistants (PDAs). The database accesses the web based platform and application based platform using an application program interface (API) and plug-in, respectively. The database is also adaptable to access the device based platforms.

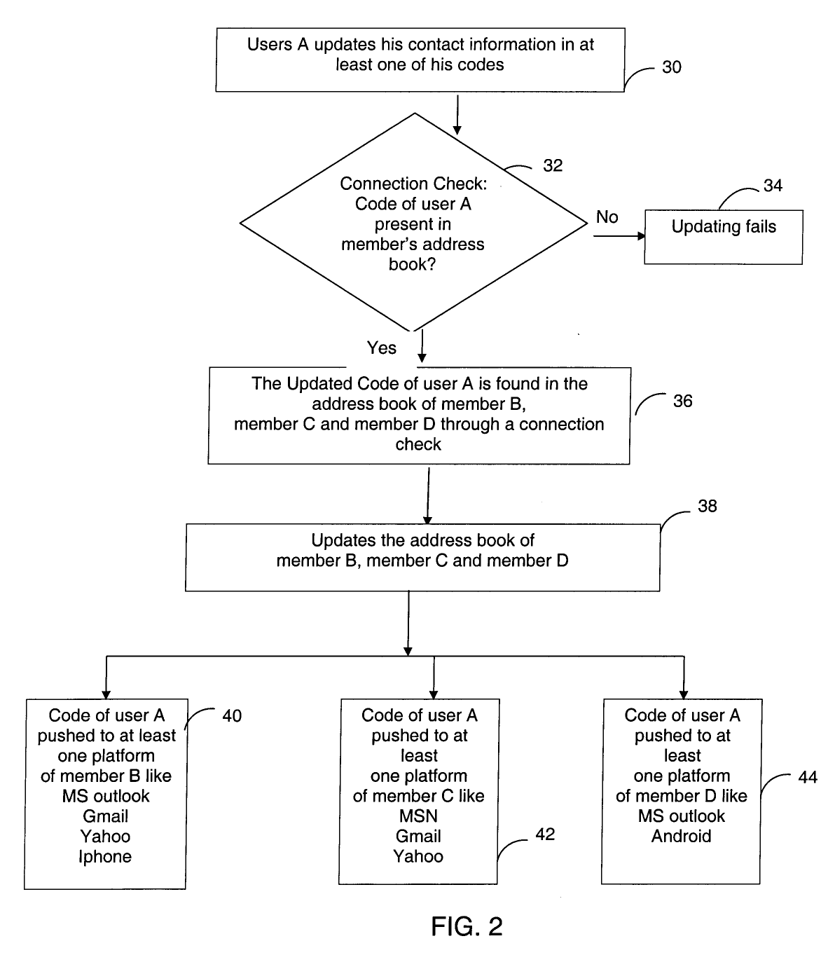

With reference to FIG. 2, a flowchart illustrates an example for updating contact information of user A stored in a platform of a member registered in the database. User A updates his own codes that hold his contact information 30. A connection check is made at block 32 to verify if the code of user A is present in another member's address book. If the check is evaluated to be true, the member's address book having the code of user A is automatically updated with the contact information of user A. In this example, the code of user A is present in the address book of member B, member C and member D as indicated at block 36. If the check is evaluated to be false, then no member has the code of user A and no updating occurs as indicated at block 34. The address books of member B, member C and member D are updated with the contact information of user A as indicated at block 38. The code of user A is pushed to the platform(s) of member B, member C and member D as indicated at blocks 40, 42 and 44, respectively.

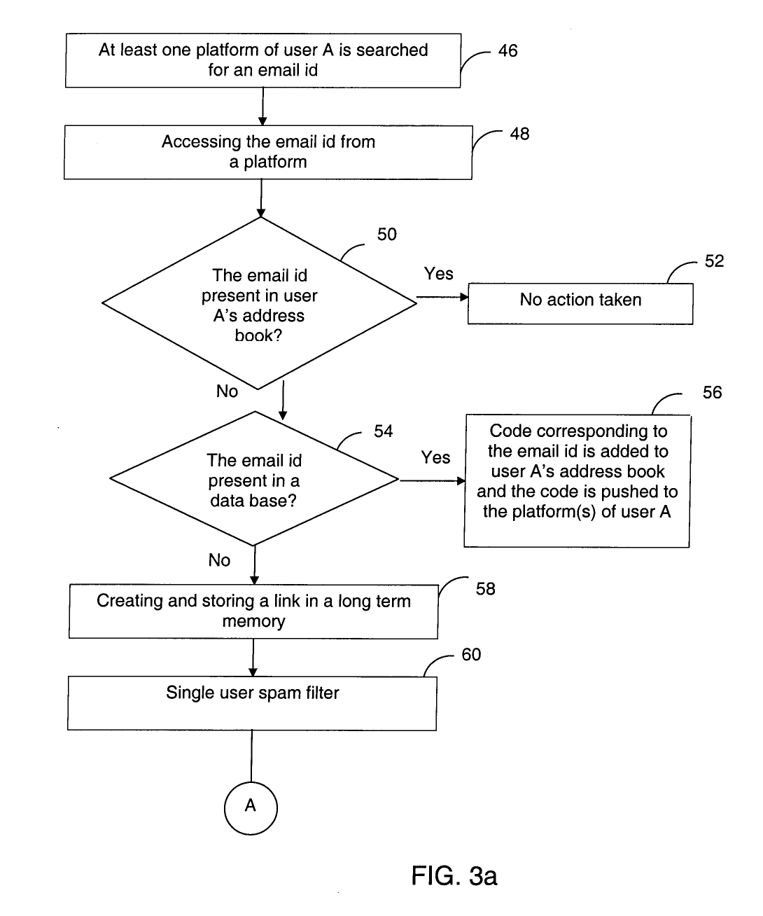

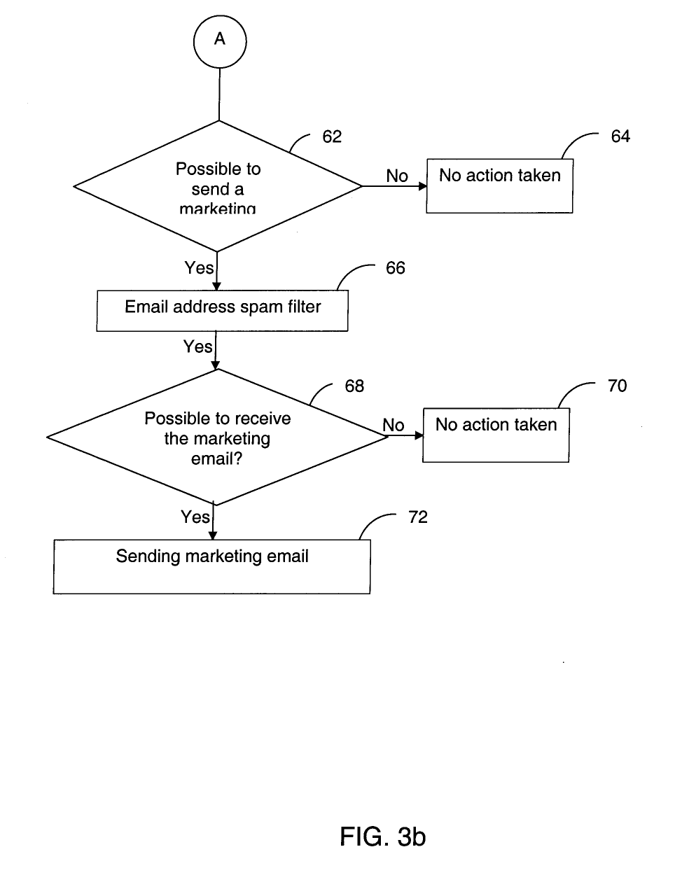

Referring to FIGS. 3a-3b, flowcharts illustrate an example for scanning a platform of user A to add a code of a member registered in the database to user A's address book. A platform of user A is searched for Email IDs as indicated at block 46. An Email ID is accessed from a platform of user A as shown at block 48. A check is made at block 50 to verify if the Email ID is present in user A's address book. If the check is evaluated to be true, no action is taken as shown at block 52. If the check is evaluated to be false, a check is made at block 54 to verify if the Email ID is present in the database. If the check is evaluated to be true, the code corresponding to the Email ID is added to user A's address book and the code is pushed to at least one platform of user A as shown at block 56. If the check is evaluated to be false, then the Email ID belongs to a person that is not registered in the database. In this case, a link between the code of user A and the Email ID of the non-registered person is created and stored in the long term memory of the database as indicated at block 58. The link stored in the long term memory records the fact that the Email ID of the non-registered person was found in a platform of user A. When the non-registered person registers into the database, the database can push the contact information of user A into a platform(s) of the non-registered person.

A single user spam filter operation is performed as shown at block 60. In the single user spam filter, user A is prevented from sending a marketing email more than once in two months to a non-registered person. A check is made at block 62 to verify the possibility of sending the marketing email to the non-registered person. If the check is evaluated to be false, no action is taken as shown at block 64. If the check is evaluated to be true, an email address spam filter operation is performed as shown at block 66. In the email address spam filter, the non-registered person is not permitted to receive more than five marketing emails from user A within one month. A check is made at block 68 to verify the possibility of the non-registered person receiving the marketing email. If the check is evaluated to be false, no action is taken as shown at block 70. If the check is evaluated to be true, the marketing email is sent to the non-registered person. The marketing email may be an invitation for the non-registered person to register into the database.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method for creating an address book for at least one user in a database and adding contact information into the user's address book of at least one member registered in the database, the method comprising the steps of:
registering at least one user into a database by entering at least one requested information;
generating a user's address book in the database and at least one code associated with the at least one user;
searching for at least one code of at least one member in the database;
checking the status of the at least one code of the at least one member;
displaying the contact information of the at least one member when the status of the at least one code is public, and if the status of the at least one code is private, asking the permission of the at least one member for displaying the contact information and displaying the contact information only if permission is granted;
adding the displayed contact information of the at least one member into the user's address book; and
pushing the at least one code of the at least one member into at least one platform of the at least one user.

2. The method of claim 1 wherein the contact information includes a telephone number, email address, phone number, fax number, mailing address, home address, or business address.

3. The method of claim 1 wherein the at least one platform includes a web based platform, application based platform and/or device based platform.

4. The method of claim 3 wherein the web based platform includes Gmail, Yahoo, Microsoft network (MSN) and/or America online (AOL).

5. The method of claim 3 wherein the application based platform includes Microsoft outlook and Android.

6. The method of claim 3 wherein the device based platform comprises mobile phones and/or personal digital assistants (PDAs).

7. The method of claim 1 wherein the at least one requested information includes a name, address, key Email ID, contact numbers and access information for the at least one platform.

8. The method of claim 7 wherein the key Email ID is the primary Email ID entered by the at least one user for registering into the database.

9. The method of claim 7 wherein the access information for the at least one platform includes a user name and password for accessing the at least one platform.

10. A method for updating contact information of at least one user in a database, wherein the contact information is stored in at least one platform of at least one member registered in the database, the method comprising the steps of:
updating the contact information of at least one user in an address book of the user stored in the database;
automatically checking to determine if at least one code associated with the at least one user is present in an address book of at least one member registered in the database;
automatically updating the member's address book with the contact information of the at least one user if the at least one code of the at least one user is present in the member's address book, and
pushing the at least one code of the at least one user into at least one platform of the at least one member.

11. The method of claim 10 wherein the at least one platform includes a web based platform, application based platform and device based platform.

12. The method of claim 11 wherein the web based platform comprises Gmail, Yahoo, Microsoft network (MSN) and America online (AOL).

13. The method of claim 11 wherein the application based platform comprises Microsoft outlook and Android.

14. The method of claim 11 wherein the device based platform comprises mobile phones and personal digital assistants (PDAs).

15. A method for scanning at least one platform of at least one user to add at least one code of at least one member registered in a database to a user's address book, the method comprising the steps of:
searching for at least one Email ID in at least one platform of at least one user;
accessing the at least one Email ID from the at least one platform of the at least one user; and
comparing the at least one Email ID with the user's address book and taking no action if the at least one Email ID is already present in the user's address book, and if the at least one Email ID is not present in the user's address book, checking the at least one Email ID in the database to determine if the Email ID is present in the database,
wherein, if the Email ID is present in the database, adding the at least one code of the at least one member corresponding to the at least one Email ID to the user's address book and subsequently pushing the at least one code of the at least one member to at least one platform of the at least one user.

16. The method of claim 15 wherein a link between the code of the at least one user and the at least one Email ID of a non-registered person is created and stored in the long term memory of the database if the at least one Email ID is not present in the database.

17. The method of claim 16 wherein a single user spam filter operation is performed to check the possibility of sending a marketing email to the non-registered person if the at least one Email ID is not present in the database.

18. The method of claim 16 wherein an email address spam filter operation is performed to check the possibility of the non-registered person receiving the marketing email, if the at least one Email ID is not present in the database.

19. The method of claim 15 wherein the at least one platform includes a web based platform, application based platform and/or device based platform.

20. The method of claim 19 wherein the web based platform comprises Gmail, Yahoo, Microsoft network (MSN) and America online (AOL).

21. The method of claim 19 wherein the application based platform includes Microsoft outlook and Android.

22. The method of claim 19 wherein the device based platform comprises mobile phones and personal digital assistants (PDAs).
